(19) United States
(12) Patent Application Publication
(10) Pub. No.: US 2004/0212253 A1
(43) Pub. Date: Oct. 28, 2004

(54) Uninterruptible power supply having programmable power output

(76) Inventor: Ming-Huang Huang, Taoyuan (TW)

Correspondence Address: APEX JURIS, PLLC, 13194 EDGEWATER LANE NORTHEAST, SEATTLE, WA, 98125, US

(21) Appl. No.: 10/421,479

(22) Filed: Apr. 22, 2003

(51) Int. Cl. H02J 7/00; H02J 9/00

(52) U.S. Cl. 307/64

(57) ABSTRACT

An uninterruptible power supply having a programmable power output is provided. The uninterruptible power supply having a programmable power output includes: a communication interface, a microprocessor, a schedule recorder, a clock generator, a input voltage/current detecting circuit, a DC/AC converter, a battery, a charging circuit, a transfer switch, and a output power control switch. Through the components described above, an user can set the power output schedule through the communication interface by employing a computer, a PDA or other equipments, and then the schedule can be stored in the schedule recorder by the microprocessor, so that the output power control switch can be controlled to decide whether a power is outputted or not through a cooperation between a time data produced by the clock generator and the schedule stored in the schedule recorder (FIG. 1).

### BACKGROUND OF THE INVENTION

1. Field of the Invention

The present invention relates to an uninterruptible power supply having a programmable power output, and particularly to an uninterruptible power supply whose power schedule can be set through a communication interface by means of a computer, a PDA or other equipments.

2. Description of the Prior Art

Generally, a conventional UPS (Uninterruptible Power Supply) is employed to immediately convert an inner battery power when an input power is abnormal, so that a power can be continuously outputted and a function of uninterruptible power supply can be achieved. However, the conventional UPS, mostly, only possesses an ability to continuously output the power when the power supply is cut off. Thus, if it is applied in an output power management of a system integration, the conventional UPS will be incapable of achieving the power management alone and, oppositely, has to cooperate with other mainframe terminals through an on-line method and the output power schedule has to be controlled through the mainframe terminal. That means when the input power is abnormal, the continuous power can be supplied by the UPS but the schedule still has to be controlled and executed by the mainframe terminal.

Thus it can be seen, the power management of the conventional uninterruptible power supply described above still has some defects when applying in the system integration, is not a good design, however, and is urgently to be improved.

Because of the technical defects of the conventional uninterruptible power supply described above, the applicant keeps on carving unflaggingly to develop the uninterruptible power supply having a programmable power output through wholehearted experience and research.

### SUMMARY OF THE INVENTION

An object of the present invention is to provide an uninterruptible power supply having a programmable power output for a power management of a system integration whose power output schedule can be set by means of an external equipment and can be stored in a schedule recorder of the uninterruptible power supply for controlling the output power.

Another object of the present invention is to provide an uninterruptible power supply having a programmable output power which can set a control device for immediately further controlling an power output status besides directly setting the schedule.

Another further object of the present invention is to provide an uninterruptible power supply having a programmable power output whose above-described control device possesses a superior authority to the originally set power output schedule, so that, in an emergency, the control device can immediately decide whether the power is outputted or not.

An additional object of the present invention is to provide an uninterruptible power supply having a programmable power output which can output the power to an equipment terminal according to the set schedule, no matter the input power is normal or not.

For achieving the purposes described above, the uninterruptible power supply having a programmable power output includes: a communication interface, a microprocessor, a schedule recorder, a clock generator, a input voltage/current detecting circuit, a DC/AC converter, a battery, a charging circuit, a transfer switch, and a output power control switch. The present invention employs a computer, a PDA or other equipments to set a power output schedule through the communication interface, and the schedule can be stored in the schedule recorder inside the microprocessor. Furthermore, through a cooperation between the clock generator and the schedule recorder, the power control switch can be controlled to output power or not. When an external input power is abnormal, the power still can be output according to the schedule through converting a power from the inner battery.

### BRIEF DESCRIPTION OF THE DRAWINGS

The drawings disclose an illustrative embodiment of the present invention which serves to exemplify the various advantages and objects hereof, and are as follows:

FIG. 1 shows an application practicing schematic view of an uninterruptible power supply having a programmable power output according to the present invention;

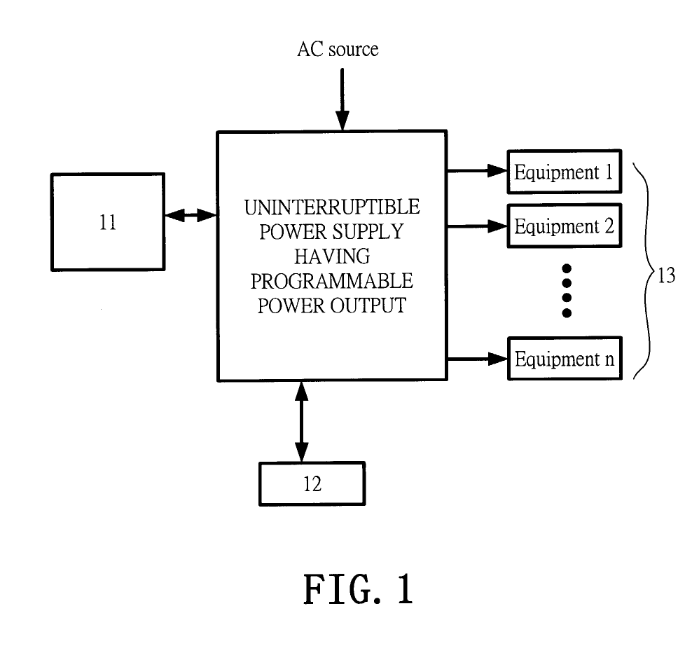

FIG. 2 shows the circuit block diagram of an uninterruptible power supply having an programmable power output in a first embodiment according to the present invention; and

FIG. 3 shows the circuit block diagram of an uninterruptible power supply having an programmable power output in a second embodiment according to the present invention.

### DETAILED DESCRIPTION OF THE PREFERRED EMBODIMENT

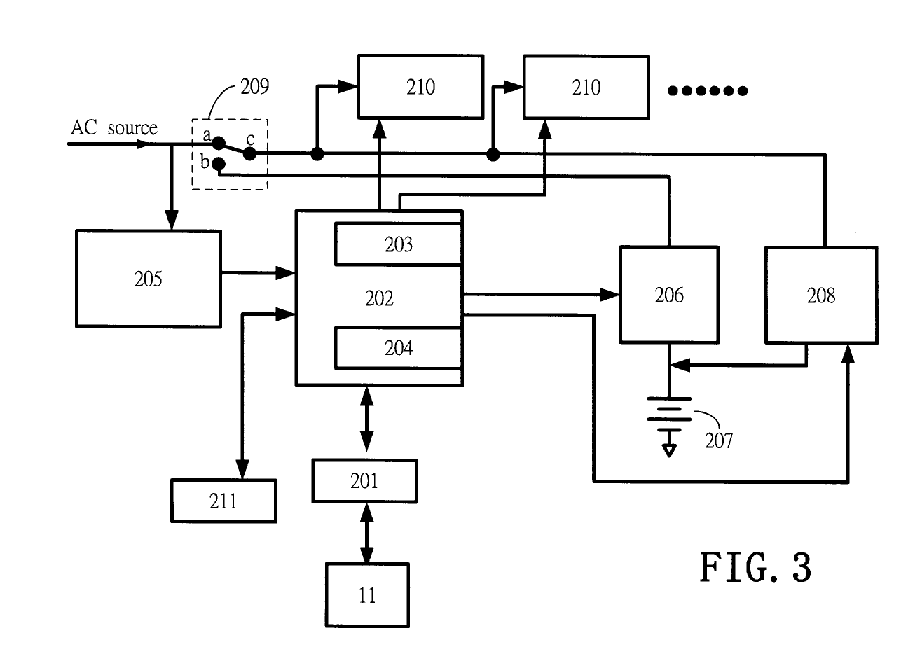

Please refer to FIG. 3. In the present invention, the input power is connected to a general AC power, the power output schedule is set by means of a computer, a PDA or other equipments 11 and the schedule is stored inside the present invention for controlling whether the power is outputted to an equipment terminal 13 or not. When the external inputted AC power is abnormal, an inner battery power can be converted to output to the equipment terminal 13 still according to the schedule. Otherwise, the present invention can further comprise a control equipment 12 for directly controlling whether the power is outputted or not in an emergency.

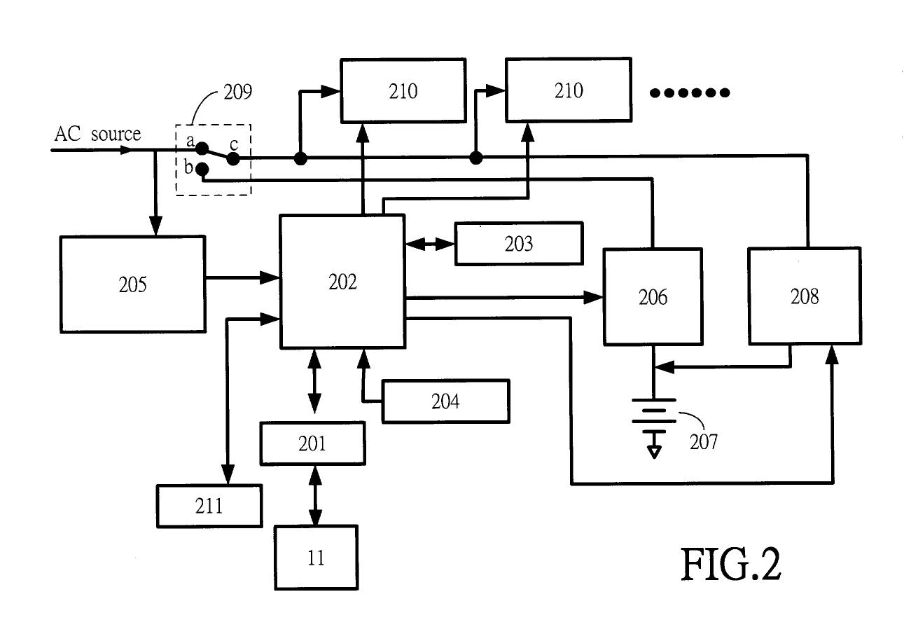

Please refer to FIG. 2. The uninterruptible power supply having a programmable power output provided by the present invention includes: a communication interface 201, a microprocessor 202, a schedule recorder 203, a clock generator 204, a input voltage/current detecting circuit 205, a DC/AC converter 206, a battery 207, a charging circuit 208, a transfer switch 209, and an output power control switch 210. The transfer switch 209 includes three contacts a, b and c, wherein a contact is connected to the general AC power, b contact is connected to the DC/AC converter 206, and c contact is connected to the output power control switch 210 and the charging circuit 208.

The input voltage/current detecting circuit 209 detects the received AC power and transmits the result to the microprocessor 202.

The clock generator 203 produces a time data and then transmits thereof to the microprocessor 202.

The communication interface 201 is employed to set the schedule by means of the connected computer, PDA or other equipments 11 and transmit the set schedule to the microprocessor 202.

The schedule recorder 203 stores the set schedule.

The battery 207 is connected to the charging circuit 208 and the DC/AC converter 206 for receiving a charging power from the charging circuit 208 or transmitting the power to the DC/AC converter 206.

When the general input AC power is normal, the input voltage/current detecting circuit 205 will transmit a detecting result to the microprocessor 202, and then the microprocessor 202 will transmit a control signal to the transfer switch 209 to connect the contacts a and c in the transfer switch 209 for transmitting the AC power to the output power control switch 210 and the charging circuit 208. Besides, the microprocessor 202 will also transmit a control signal to the charging circuit 208 for transmitting a charging power to the battery 207. When the input AC power is abnormal, the input voltage/current detecting circuit 205 will transmit the detecting result to the microprocessor 202 so as to transmit a control signal to the transfer switch 209 to connect the contacts b and c. At the same time, the microprocessor 202 also can transmit a control signal to the DC/AC converter 206 for converting the battery power and then transmitting thereof to the output power control switch 210.

The microprocessor 202 cooperates with the time data produced by the clock generator 204 and stands on the schedule stored in the schedule recorder 203 to control the output power control switch 210 to decide whether a power is outputted to the equipment terminal or not.

In addition, besides the set output power schedule, the present invention can further comprise a control device 211. The control device 211 can be a control panel, a control switch or other relative control devices. Thus, besides directly setting the schedule through the microprocessor 202, the control device 11 also can immediately control the output of the power through the microprocessor 202 for instantaneously control the power output status. Furthermore, the control device 211 possesses a superior authority to the original set power output schedule, so that, in an emergency, the control device 211 can immediately decide whether the output of the power is enforced or not.

As shown in FIG. 3, the schedule recorder 203 or the clock generator 204 can directly be set inside the microprocessor.

The uninterruptible power supply having a programmable output power according to the present invention, when being compared with other prior arts, further includes the advantages as follows:

1. The present invention provides an uninterruptible power supply having a programmable power output which can be applied in a power management of a system integration and can set the output power schedule, which can be stored in a schedule recorder thereof, by means of an external equipment for controlling the output power without separately setting a mainframe to control the schedule through an on-line method.

2. The present invention provides an uninterruptible power supply having a programmable power output which can further set a control device for immediately controlling an output power status, besides directly setting a schedule.

3. The present invention provides an uninterruptible power supply having a programmable power output whose above-describe control device possesses a superior authority to an original set schedule status of the power output, so that, in an emergency, the control device can immediately decide whether the power is outputted or not.

4. The present invention provides an uninterruptible power supply having a programmable power output which can output a power to an equipment terminal according to a set power output schedule, no matter the input power is normal or not.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An uninterruptible power supply having a programmable power output, comprising:
a microprocessor for producing a control signal;
a battery;
a charging circuit for charging said battery according to said control signal produced by said microprocessor;
an output power control switch for outputting a power according to said control signal produced by said microprocessor;
a DC/AC converting circuit for converting and outputting a power of said battery according to said control signal produced by said microprocessor;
a transfer switch comprising three contacts a, b and c, wherein said a contact is connected to a general AC power, said b contact is connected to said DC/AC converter, said c contact is connected to said output power control switch and said charging circuit, and said transfer switch switches a connection of a with b and b with c;
an input voltage/current detecting circuit for detecting said AC power and outputting a detecting result to said microprocessor;
a clock generator for producing a time data and outputting said time data to said microprocessor;
a communication interface for being employed to set a schedule by means of one selected from a group consisting of a computer, a PDA and other equipments and transmit said schedule to said microprocessor; and
a schedule recorder for storing said schedule received by said microprocessor.

2. The uninterruptible power supply having a programmable power output according to claim 1, wherein said clock generator is directly set inside said microprocessor.

3. The uninterruptible power supply having a programmable power output according to claim 1, wherein said schedule recorder is directly set inside said microprocessor.

4. The uninterruptible power supply having a programmable power output according to claim 1 further comprising a control device for directly controlling said schedule through said microprocessor.

5. The uninterruptible power supply having a programmable power output according to claim 4, wherein said control device controls a status of said output power control switch immediately.
